(19) United States
(12) Patent Application Publication
(10) Pub. No.: US 2024/0204221 A1
(43) Pub. Date: Jun. 20, 2024

(54) AIR-SUPPLY DEVICE, FUEL-CELL SYSTEM AND VEHICLE

(71) Applicant: CELLCENTRIC GMBH & CO. KG, Kirchheim/Teck-Nabern (DE)

(72) Inventor: Michael PROCTER, Burnaby (CA)

(21) Appl. No.: 18/555,936

(22) PCT Filed: May 6, 2022
(86) PCT No.: PCT/EP2022/062291

§ 371 Date: Oct. 18, 2023

(30) Foreign Application Priority Data
May 7, 2021 (DE) 10 2021 204 650.9

(51) Int. Cl. H01M 8/04111; H01M 8/04082; H01M 8/04089

(52) U.S. Cl. CPC H01M 8/04111; H01M 8/04097; H01M 8/04201; H01M 2250/20

(57) ABSTRACT

The invention relates to an air-supply device for fuel-cell systems with two-stage compression. The invention is characterized in that for supplying to fuel-cell stacks electrically connected in parallel, a turbocompressor which is mechanically coupled to an exhaust-air turbine for the respective fuel-cell stack is provided for each of the fuel-cell stacks, wherein at least one electrically driven flow compressor, which respectively provides at least two of the turbocompressors with air in parallel, is provided upstream of the respective turbocompressor in the direction of flow of the compressed air. A fuel-cell system with at least two fuel-cell stacks comprises such an air-supply and can be used for example in a vehicle, in particular in a commercial vehicle.

The invention relates to an air-supply device for fuel-cell systems with two-stage compression. The invention also relates to a fuel-cell system with such an air-supply device and a vehicle with such a fuel-cell system.

The use of fuel-cell systems to generate electrical power, for example for stationary applications or in particular also electrical drive power for vehicles, is known from the prior art. PEM fuel-cells are often used, which are supplied with air as an oxygen supplier on the cathode side. Single-stage flow compressors are often used for air-supply. It is particularly common that these flow compressors are connected to an exhaust-air turbine and an electric machine and form a so-called electric turbocharger or motor-assisted turbocharger. The energy contained in the exhaust air of the respective fuel-cell can thus be at least partially recovered and used to supply air.

It is always problematic that such structures work with their operating characteristic curve very close to the surge limit. In order to ensure reliable supply to the fuel-cell in partial load operation without exceeding the surge limit, a so-called blow-by valve, which is also referred to as a waste gate valve, is typically present.

In practice, this leads to a limitation in terms of the free choice of operating points on the one hand and, in the event that compressed supply air already flows through the blow-by valve, to a loss of performance on the other hand, since only part of the energy added during compression can be recovered in the exhaust air.

In order to counteract this problem, a fuel-cell air-supply is known from WO 02/086997 A2, which is designed as a two-stage system. This means that a high degree of variability in volume flows and pressures can be achieved, regardless of the surge limit. The structure is designed in such a way that the first stage is formed by an electrically driven flow compressor and the second compression stage is formed by a turbocompressor. This is coupled directly to the exhaust-air turbine via the shaft and is therefore implemented as a freewheeler. The exhaust-air turbine has a variable turbine guide grille. A blow-by valve is still provided in the structure described, but would in principle be expendable in this case.

Now it is the case that fuel-cell systems are increasingly being used to provide relatively high power, for example to drive commercial vehicles such as buses, trucks or the like. In order to achieve a simple and, if necessary, scalable adjustment of the performance according to different sizes of commercial vehicles, several fuel-cell stacks are electrically combined within the fuel-cell system. A typical structure, for example, provides for two electrically parallel connected fuel-cell stacks in such a structure. Since both fuel-cell stacks are to be controlled independently of one another with regard to both the fuel supply and the air-supply, two air-supply systems are typically provided parallel to one another in the structures known from the general prior art. These are usually two separate electric turbochargers in the sense described above, which then require two blow-by valves, two converters, two electric motors and the like.

The object of the present invention is to simplify this structure, which is basically known from the prior art, and to improve it with regard to the variability that can be achieved in the air-supply to the fuel-cell systems.

According to the invention, this object is achieved by an air-supply device for fuel-cell systems having the features of claim 1, and here in particular the characterizing part of claim 1. Furthermore, the object is achieved by a fuel-cell system having such an air-supply device. A vehicle having such a fuel-cell system can also achieve the object. Advantageous embodiments and developments of the air-supply device and of the vehicle additionally result from the dependent claims.

The air-supply device according to the invention provides for supplying of electrically parallel operating fuel-cell stacks for each of the fuel-cell stacks a turbocompressor, which is mechanically coupled to an exhaust-air turbine for the respective fuel-cell stack. In the direction of flow of the compressed air upstream of the turbocompressor, at least one electrically driven flow compressor is provided, which respectively provides at least two of the turbocompressors with air in parallel.

The turbocompressors, which are each designed as freewheeler in direct mechanical connection with an exhaust-air turbine, herein form the second compressor stage of a two-stage air-supply device. They are each associated with one of the fuel-cell stacks, which are operated in parallel in the overall system and are typically electrically connected in parallel. In principle, however, an electrical series connection would also be conceivable.

The first stage of compression in the air-supply device is now formed by an electrically driven flow compressor for at least two respective turbocompressors. In the typical structure with two fuel-cell stacks, an electrically driven flow compressor as the first compression stage thus supplies two turbocompressors as the second stage of compression, which in turn supply a fuel-cell stack associated therewith. The cathode-side exhaust air from this fuel-cell stack then reaches the environment via the exhaust-air turbine connected to the respective turbocompressor, so that residual energy in the exhaust air drives the second compression stage for the respective fuel-cell stack via the exhaust-air turbine. The two turbocompressors then have a common flow compressor, which supplies them with air on the low-pressure side and thus forms the first common compression stage for both turbocompressors.

This design now makes it possible to use the advantages of two-stage compression in order to have a high degree of freedom in choosing the operating points without running the risk of exceeding the surge limit. The design is also compact and efficient, as it relies, in the region of both turbocompressors, as a second stage, on the simple and efficient freewheelers without an electric machine. As the first stage of compression, the structure uses a flow compressor, which is also simple and can, for example, comprise a larger circumference of its compressor wheel than the two turbocompressors, in order to provide the required amount of air at moderate speeds and with a correspondingly simple and inexpensive drive motor.

The structure then only requires a single electric motor with the corresponding converter for both parallel fuel-cell stacks and, due to the two-stage compression, can in particular dispense with the blow-by valves. This leads to a significant cost and space advantage with regard to the saved components, in particular with regard to the saved electrical components and their control.

According to an extremely advantageous development of the air-supply device according to the invention, at least one of the exhaust-air turbines comprises a variable turbine guide grille. Preferably, according to an advantageous development, this can also apply to all exhaust-air turbines. Using such a variable turbine guide grille in the region of the exhaust-air turbines, the energy provided via the exhaust air from the fuel-cell in the respective exhaust-air turbine can be varied accordingly in order to achieve a high degree of variability when driving the turbocompressor in the second compression stage. As a result, both fuel-cell stacks operated in parallel can be controlled largely independently of one another with regard to the amount of air with which they are supplied. This enables a very advantageous operation of the respective fuel-cell stack with regard to its air-supply that is largely independent of the other fuel-cell stack. Together with a simple controllable metering valve for hydrogen on the anode side, each of the fuel-cell stacks can be operated independently of the respective other fuel-cell stack.

Another very crucial aspect is that the at least one variable turbine geometry and an electric drive motor of the flow compressor are controlled via a common control in order to also reduce the effort related to the control. In particular, the control can also control the metering of hydrogen on the anode side of the respective fuel-cell stack in order to be able to individually control the electrical power provided in the at least two parallel operated fuel-cell stacks.

As already mentioned, according to a particularly advantageous embodiment, it can be provided that the structure comprises exactly one flow compressor and exactly two turbocompressors and is intended to supply air to two fuel-cell stacks operated in parallel.

A further advantageous embodiment further provides that a respective intercooler is arranged in the flow direction downstream of the turbocompressor in order to appropriately cool the hot and typically dry charge air after compression in the two-stage compression process and, if necessary, to humidify via a humidifier following the intercooler or in combination with the intercooler.

A fuel-cell system according to the invention can now comprise at least two fuel-cell stacks and an air-supply device in the manner described. This makes it possible to ideally utilize the advantages described with regard to the air-supply and the possibilities provided by the air-supply during efficient operation and individual control of at least two fuel-cell stacks within a fuel-cell system.

A vehicle according to the invention accordingly comprises such a fuel-cell system with at least two, preferably exactly two, fuel-cell stacks. The vehicle can be designed as a commercial vehicle, for example as a truck or bus.

Further advantageous designs of the air-supply device, the fuel-cell system, and the vehicle according to the invention also result from the exemplary embodiment, which is explained in more detail hereinafter with reference to the figures.

In particular:

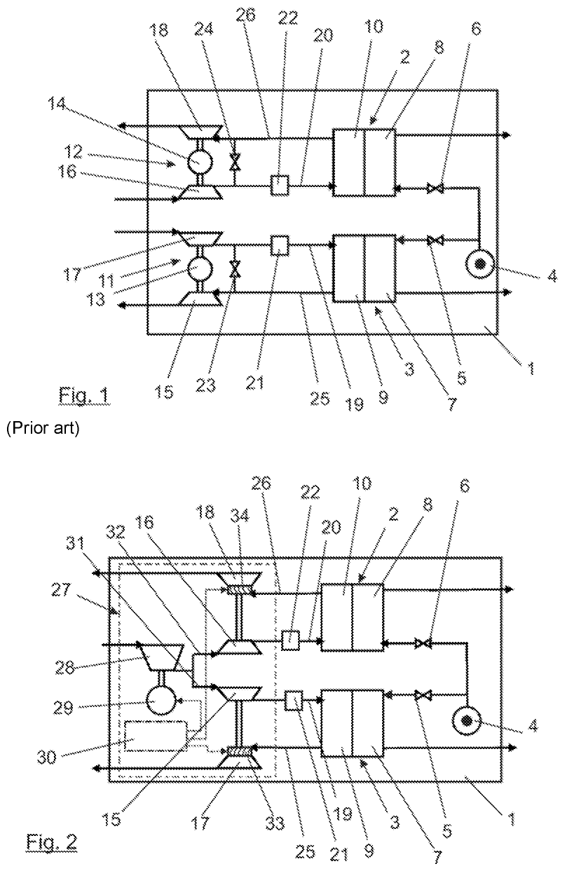

FIG. 1 a representation of a fuel-cell system with two fuel-cell stacks and two air-supply systems according to the prior art; and

FIG. 2 a structure analogous to that in FIG. 1 with an air-supply device in a possible embodiment according to the invention.

In the representation of FIG. 1, a vehicle 1, for example a utility vehicle or a passenger vehicle, is indicated very schematically. It should obtain its electrical drive power, or at least part of its electrical drive power, from two fuel-cell stacks 2, 3. The fuel-cell stacks 2, 3 are operated in parallel and are in particular electrically connected in parallel. The structure has a common hydrogen source 4, which can be designed, for example, as a compressed gas storage, as a cryogenic storage or the like. Via the hydrogen source 4, hydrogen is fed into anode spaces 7, 8 of the two fuel-cell stacks 2, 3 via two separate pressure control and metering valves 5, 6. In the exemplary embodiment shown here, unused hydrogen enters the environment together with exhaust gases.

This is just a schematic representation. It is clear to the person skilled in the art that further components such as anode circuits can be arranged here or measures can be taken to feed the exhaust gas, for example to the exhaust air, and dilute it accordingly. Since the anode side is of secondary importance for the present invention, it will not be discussed further.

To supply air to the two cathode spaces 9, 10 of the two fuel-cell stacks 2, 3, respective electric turbochargers 11, 12 are provided in this structure according to the state of the art. They both have an electric drive machine 13, 14 and a turbocompressor 15, 16. An exhaust-air turbine 17, 18 of the electric turbocharger is also arranged together with these two components on a common shaft. An intercooler 21, 22 is also provided in a supply air line 19, 20 to the respective fuel-cell stack 2, 3. The supply air lines 19, 20 to the two fuel-cell stacks 2, 3 are also connected to the respective exhaust air lines 25, 26 of the fuel-cell stacks 2, 3 via so-called blow-by valves 23, 24, which are also referred to as waste gate valves, in order to blow off compressed air after the respective turbocompressor 17, 18, if necessary, when the respective fuel-cell stack 2, 3 is operated in partial load operation. This is necessary to safely prevent the surge limit from being exceeded at certain operating points. The structure enables the two fuel-cell stacks 2, 3 to be supplied with air independently of each other, but is relatively complex in terms of the components required and their control.

The illustration in FIG. 2 now shows a structure with an air-supply device 27, which offers decisive advantages. The two fuel-cell stacks 2, 3 with their supply lines and discharge lines as well as the two intercoolers 21, 22 are shown and are meant to be understood analogously to the illustration in FIG. 1. This structure, as well as the entire anode side of the fuel-cell system, which is only shown here as an example and in a schematic manner, will not be discussed further.

The air-supply device 27 now serves to supply air to the two fuel-cell stacks 2, 3 independently of one another and is designed as a two-stage air-supply device 27. The first stage forms a common flow compressor 28 with an electric drive machine 29 for both fuel-cell stacks 2, 3. This is controlled accordingly via a common control 30, as are other components mentioned later. The air flow of the flow compressor 28 is then divided into two parallel intake lines 31, 32 and supplies two turbocompressors with air, which are again designated here with the reference numbers 15, 16, in analogy to the illustration in FIG. 1. These two turbocompressors 15, 16 now form the second compression stage and supply the air compressed by them as an oxygen supplier via the intercoolers 21, 22 through the supply air lines 19, 20 into the cathode spaces 9, 10 of the two fuel-cell stacks 2, 3.

In contrast to the structure in FIG. 1 according to the prior art, they are constructed as so-called freewheeling compressors, which are arranged on a common shaft with their respective exhaust-air turbine 17, 18. However, without the electric machine of the two electric turbochargers 12, 13 according to the prior art, this structure can be implemented much more simply and efficiently. In addition to the structure previously described in the context of FIG. 1, both exhaust air turbines 17, 18 are respectively provided with a variable turbine guide grille 33, 34. These turbine guide grilles 33, 34 are controlled independently from one another via the common control 30. This makes it possible, with a common first stage of compression via the flow compressor 28, via the two turbocompressors 15, 16, independently from one another, to accordingly adjust the amount of air supplied to the respective fuel-cell stack 2, 3 or its cathode space 9, 10. Similar to the construction in the prior art of FIG. 1, despite the simpler structural design with fewer components, both fuel-cell stacks 2, 3 can be controlled independently of one another with regard to their air-supply. Together with the control of the metering valves 5, 6, which can be implemented independently and very easily in any case, a largely mutually independent operation of the two fuel-cell stacks 2, 3 is possible. The two-stage design also means that the blow-by valves 23, 24 can be dispensed with, which valves of course could in principle still be provided if they were needed, for example, for other reasons, as a system bypass or the like.

What is claimed is:

1. An air-supply device for fuel-cell systems with two-stage compression,
characterized in that
for supplying fuel-cell stacks electrically connected in parallel, a turbocompressor which is mechanically coupled to an exhaust-air turbine for the respective fuel-cell stack, is provided for each of the fuel-cell stacks, wherein at least one electrically driven flow compressor which respectively provides at least two of the turbocompressors with air in parallel, is provided upstream of the respective turbocompressor in the direction of flow of the compressed air.

2. The air-supply device according to claim 1,
wherein
at least one of the exhaust-air turbines comprises a variable turbine guide grille.

3. The air-supply device according to claim 1,
wherein
each of the exhaust-air turbines comprises a variable turbine guide grille.

4. The air-supply device according to claim 1,
wherein
the at least one variable turbine guide grille and a drive motor of the flow compressor are controlled via a common control.

5. The air-supply device according to claim 1.
wherein
one flow compressor and exactly two turbocompressors are provided.

6. The air-supply device according to claim 1,
wherein
a respective intercooler is arranged in the flow direction downstream of the respective turbocompressor.

7. A fuel-cell system comprising at least two fuel-cell stacks and an air-supply device according to claim 1.

8. A vehicle comprising at least one fuel-cell system according to claim 7.

9. The vehicle according to claim 8,
wherein
it being designed as a commercial vehicle.

10. The air-supply device according to claim 2, wherein
each of the exhaust-air turbines comprises a variable turbine guide grille.

11. The air-supply device according to claim 2, wherein
the at least one variable turbine guide grille and a drive motor of the flow compressor are controlled via a common control.

12. The air-supply device according to claim 3, wherein
the at least one variable turbine guide grille and a drive motor of the flow compressor are controlled via a common control.

13. The air-supply device according to claim 2, wherein
one flow compressor and exactly two turbocompressors are provided.

14. The air-supply device according to claim 3, wherein
one flow compressor and exactly two turbocompressors are provided.

15. The air-supply device according to claim 4, wherein
one flow compressor and exactly two turbocompressors are provided.

16. The air-supply device according to claim 2, wherein
a respective intercooler is arranged in the flow direction downstream of the respective turbocompressor.

17. The air-supply device according to claim 3, wherein
a respective intercooler is arranged in the flow direction downstream of the respective turbocompressor.

18. The air-supply device according to claim 4, wherein
a respective intercooler is arranged in the flow direction downstream of the respective turbocompressor.

19. The air-supply device according to claim 5, wherein
a respective intercooler is arranged in the flow direction downstream of the respective turbocompressor.

20. A fuel-cell system comprising at least two fuel-cell stacks and an air-supply device according to claim 2.
